(19) United States
(12) Patent Application Publication
(10) Pub. No.: US 2019/0184548 A1
(43) Pub. Date: Jun. 20, 2019

(54) Robot arm design for high force delivery

(71) Applicant: Satyajit Patwardhan, Fremont, CA (US)

(72) Inventor: Satyajit Patwardhan, Fremont, CA (US)

(73) Assignee: ConnectMyEV Inc., Fremont, CA (US)

(21) Appl. No.: 15/844,553

(22) Filed: Dec. 17, 2017

(51) Int. Cl. B25J 9/00; B25J 9/04; B25J 9/10

(52) U.S. Cl. CPC B25J 9/0009; B25J 9/102; B25J 9/046

(57) ABSTRACT

This patent teaches a novel approach to deliver sufficiently high force at the end effector of a robot, without making the overall robot bulky. Instead of transferring the force at the end effector to the predecessor link, the innovative approach taught in this patent consists of transferring the end effector's force directly to ground or to a suitable frame such as conveyer frame in case of spot welding application. Many times, a ground or suitable frame may not be available to transfer the force, but many other times, there is such a frame available, and the technology described in this patent can become critical in designing a compact, lightweight robotic arm and may make a difference between having a viable product or not.

### FIELD OF THE INVENTION

The general field of this invention is construction of robotic arm required to deliver force through an end effector attached at or near one of its ends. More specifically, this invention teaches a novel way of constructing a robot arm that is carrying payload or delivering force at the first of its extremity and supported by a joint at the second extremity. This joint at the second extremity, transfers reaction force and bending moment that arise out of delivering force at the end effector, to the predecessor arm or to the ground. Thus, in order to support force at the end effector, the robot arm in question, its predecessor arm or arms, and all the joints across each of the robot arms are required to be progressively stronger, thus making the overall robot bulky. This is the traditional design approach for robot arms in prior art. However frequently the robot end effectors are required to deliver the force against a static or quasi static structure. Such examples are robots doing spot welding of an automotive chassis. Here the robot is applying spot welding force against automotive chassis, which itself is riding on a conveyor frame. Another example is a robot establishing a charging connection to an electric vehicle, where the robot end effector needs to deliver insertion or contact force to establish sufficient forces across the contactor interface while sliding the contacts together.

### BRIEF DESCRIPTION OF DRAWINGS

FIG. 1: Typical robot arm prevalent in prior art: Isometric view.

FIG. 2: Typical robot arm prevalent in prior art: Side view.

FIG. 3: Floating robot arm realized using rotational motion, showing significantly reduced joint force: Deployed position.

FIG. 4: Floating robot arm in retracted position.

FIG. 5: Floating robot arm realized using linear motion: Deployed position, side view.

FIG. 6: Floating robot arm realized using linear motion: Deployed position, isometric view.

FIG. 7: Floating robot arm realized using linear motion: Retracted position, isometric view.

FIG. 8: Floating robot arm realized using linear motion: Retracted position, isometric view.

FIG. 9: Floating robot arm realized using rotational motion in deployed position, and leveraging support from workpiece frame.

FIG. 10: Floating robot arm realized using rotational motion in deployed position, and leveraging support from workpiece frame.

FIG. 11: Floating robot arm realized using rotational motion in deployed position, and leveraging support from workpiece frame, showing vibration isolation capabilities of floating robot arm design.

FIG. 12: Application example of innovation presented in this patent for EV charging from bottom of the EV.
Error! Application example of innovation presented in this patent for EV charging from
Reference side or front of the EV.
source
not
found.:

FIG. 13: Application example of innovation presented in this patent for EV charging from side or front of the EV.

### PRIOR ART RELATED TO THE INVENTION

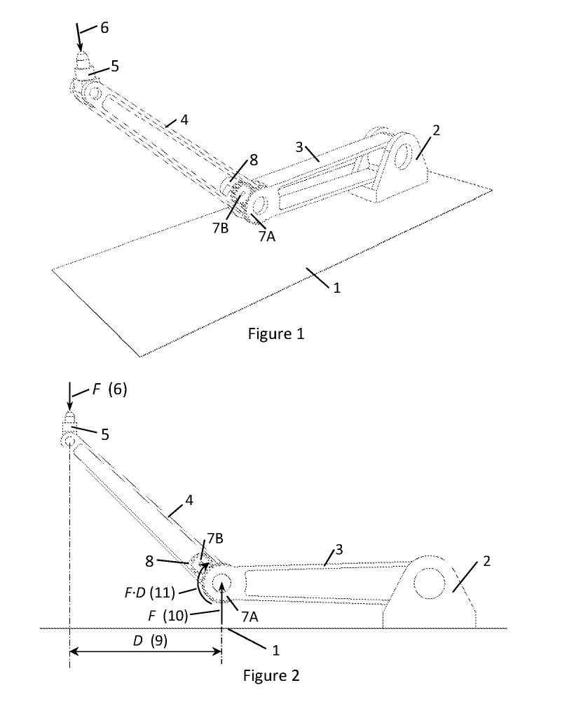

A traditional robot arm design prevalent in prior art is picturized in FIG. 1. Although specific robot arms may differ in design, FIG. 1 essentially captures the basic design elements on all such designs. In particular this innovation focuses on the arm 4. On one end of this arm, an end effector 5 is attached. This end effector is required to support force 6 demanded by the function the robot is carrying out. On the other end, the arm 4 is connected to a series of kinematic linkages represented by arm 3, swivel base 2, which is finally mounted to a stable base 1. The joint between arm 4 and arm 3 is actuated by a motor 8 and gears 7A, 7B. The side view of the same arm is shown in FIG. 2. The motor 8 and gearbox 7A, 7B moves arm 4 relative to its predecessor arm 3. The motor's holding torque and joint bearings transmit the reaction force and bending moment required to support force 6 of magnitude F imposed on end effector to the predecessor arm 3. The holding force 10 at the joint of arms 3 and 4 is equal to F, but in opposite direction. The bending moment 11 at the joint of arms 3 and 4 is F·D, where D is the moment arm of force F, as viewed from the joint of arms 3 and 4. This force 10 and bending moment 11 are borne by arm 3 and subsequently transmitted to the support 1. In order to perform this task, the actuation mechanism comprising of motor 8 and gearbox 7A & 7B as well as the arm 3, base 2, and the support 1 need to be appropriately strong. Within the range of hardware implementation and specific application needs, a real robot may look slightly different, but it will still follow the basic force and bending moment transmission structure. Such traditional design is appropriate in many cases where the robot does not have a readily available ground or a rigid frame to which it can lean against. Hence the traditional robots must be designed with enough strength and may become bulky.

### DETAILED DESCRIPTION OF THE INVENTION

This patent teaches a novel method wherein a robot arm design can take advantage of a nearby rigid structure to significantly reduce the strength requirements of the entire robot. In essence—if designed correctly, a robot arm can lean on the nearby rigid structure and directly transmit the end-effector force to this rigid structure and effectively reduce the strength requirements of the robot. A convenient rigid structure to lean on may not always be available. However if available, this patent teaches a design philosophy to take advantage of it and effectively extract many advantages such as lighter compact design, immunity from vibration.

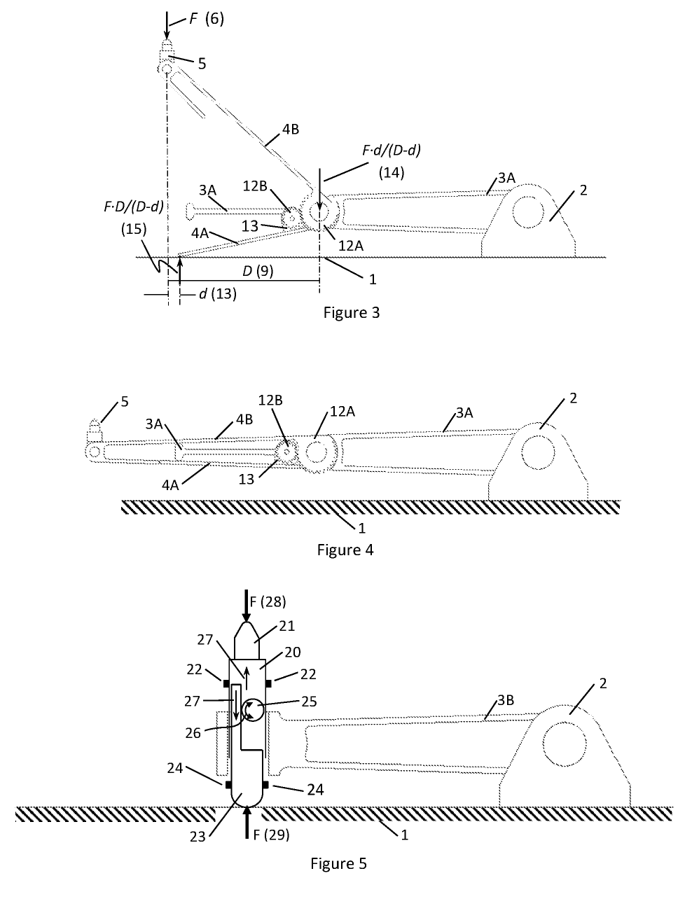

The arrangement: The basic concept of innovative design to reduce the joint forces and strength requirements of robotic systems is presented in its deployed form is presented FIG. 3. In FIG. 4 the robot arm is shown in its retracted from. The arm 4 is split into two parts arm 4A and arm 4B. The arm 3 is modified to the shape 3A. Arm 4A and 4B are free to rotate with respect to its predecessor arm 3A. The end effector 5 is carried by the new arm 4B. The original motor 8 and gearbox 7A & 7B, which was originally designed to move 4 with respect to 3A, is now modified to motor 13 and gearbox 12A & 12B designed to move 4A with respect to 4B, with both 4A and 4B free to rotate with respect to 3.

The operation: As an immediate consequence the bending moment transmitted to arm 3A is reduced to zero. The arm 4A+4B starts in its home position shown in FIG. 4. As the 4A and 4B are made to move with respect to each other, 4A first starts rotating counterclockwise while 4B continues resting against extension if 3A. Once 4A reaches a stiff structure, 4B and end effector 5 start their motion which is essentially same as the motion of the original arm 4, eventually leading end effector 5 to its same original interaction point with the workpiece. Motor 13 and gearbox 12A+12B continue to exert torque until the desired force F is created at the interface between end effector 5 and workpiece.

Advantages: The force analysis of the arm 4 reveals that most of the required reaction force is derived from interaction between 4A and the stiff structure 1—it leans against. This force is F·D/(D−d), where d is the moment arm of the end effector force when viewed from the contact point between 4A and the stiff structure 1. Consequently, the remainder of the reaction force, is supported by arm 3A through its joint with 4A and 4B. This force is merely F·d/(D−d). As can be visualized from FIG. 3, d can be made to approach zero or at least can be made significantly smaller than D. When d is made to approach zero, the force across 4A and 1 will approach the end effector force F, and the force across 3A and (4a+4B) will approach zero. This—near zero force transmittal to arm 3A and the inherent fact described earlier that there is no bending moment transmitted to 3A, will allow for lighter and compact design for 3A and 2.

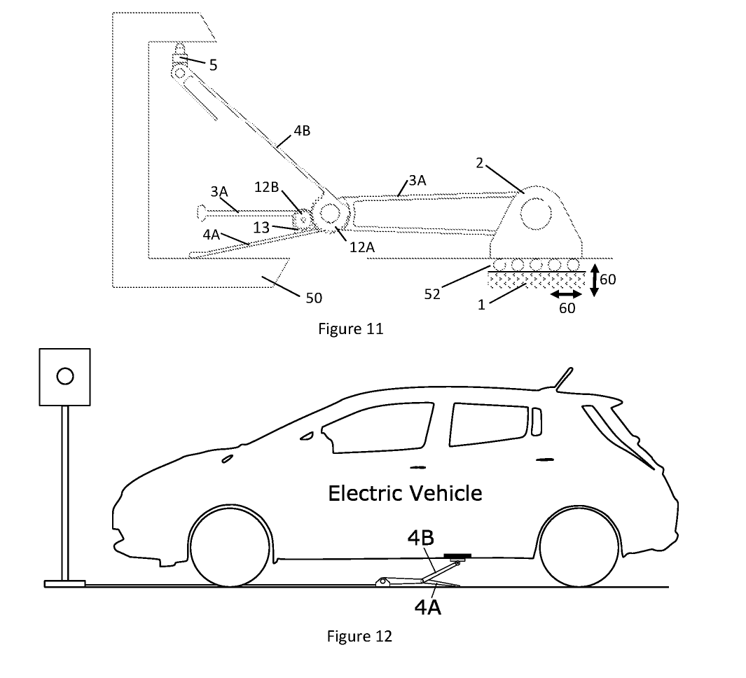

Three variants of this basic arrangement are shown in FIG. 9, FIG. 10 and FIG. 11. Each of those variations offer more specific advantages. FIG. 9 shows that if a suitable extension of the workpiece 50 is available, then 4A can be advantageously made to lean against that extension. This may be the case when a spot welding robot is welding an automobile frame which itself is being carried on a conveyer. Then the lean-against point could be other suitable part of the frame or part of the conveyer. FIG. 10 shows that the force exerted at end effector 5 can be oriented differently as long as a suitable manner of leaning is chosen for 4A. Furthermore, as shown in FIG. 11, if the base 2 is mounted on suitable roller bearings 52, this arrangement can isolate the relative vibrations (60) between robot mount 1 and the workpiece 50.

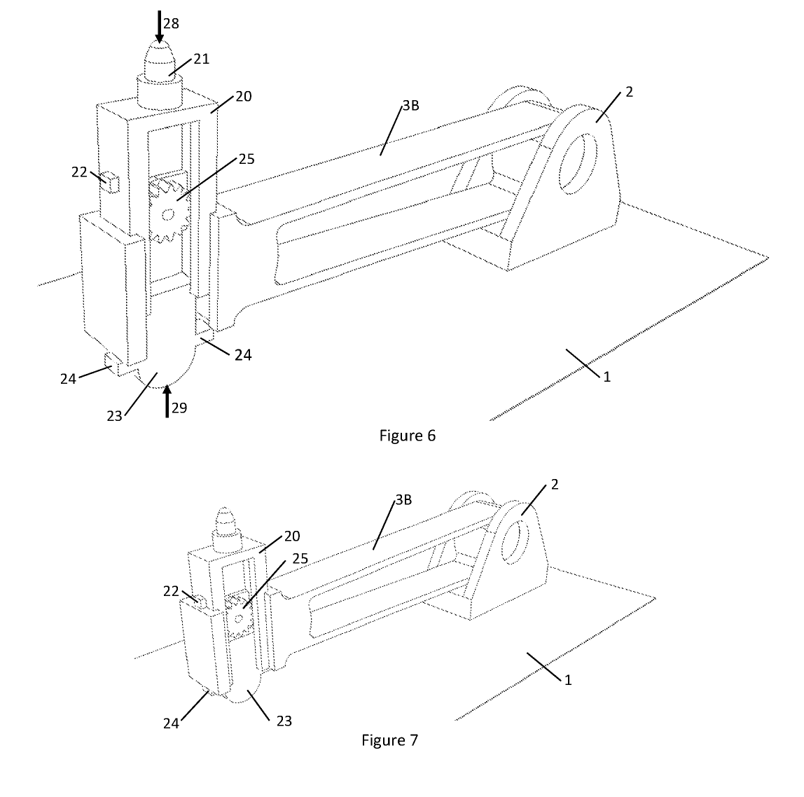

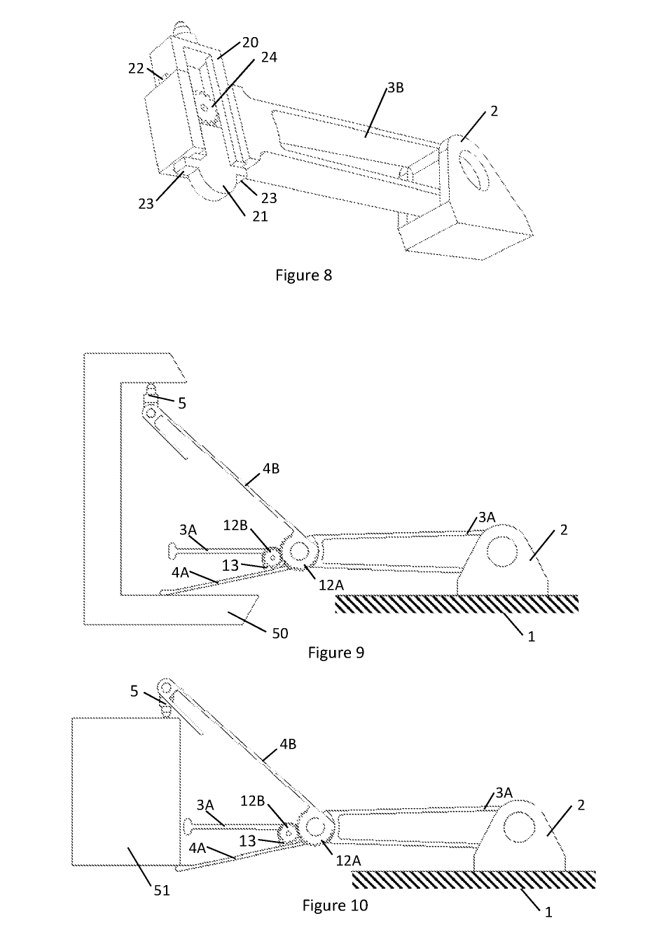

Variations: The arrangement presented in FIG. 3 is an example of using a revolute pair to move the end arms 4A+4B in order to deliver end effector force. However the principle presented in this invention can also equally apply for other types of joints. For example, FIG. 5, FIG. 6, FIG. 7 and FIG. 8 show how the same concept can be used when a prismatic joint is used to deliver force 28 at the end effector 21. The end effector 21, the stoppers 22 are integral part of first half (20) of a prismatic pair. The prismatic pair is comprised of elements 20 (first half) and 23 (second half) sliding with respect to each other. The sliding is actuated by a suitable gearing (rack and pinion shown as example here) and a motor, collectively labeled as 25. Another pair of stopper 24, are integral part of 23. The prismatic pair 20-23 is carried by the modified version 3B or original link 3 using another prismatic pair formed by the interface of 20 and 3B. Part 20 is free to move linearly with 3B except its motion is arrested when the stoppers 22 press against 3B. Part 23 is free to move linearly with respect to 3B, except its motion is arrested when the stoppers 24 press against 3B.

In its retracted form, the mechanism is shown in FIG. 7 and FIG. 8. In this configuration, the prismatic joint 20−23 is pulled together such that stops 22 and 24 press against the arm 3B. When actuator 25 is actuated to move 20 and 23 away from each other, 23 first moves downward till it hits the stiff base 1, while 20 with its tabs 22, continues to rest against 3B. When actuator 25 continues to separate 20 and 23, the part 20 starts is upward motion till the end effector 21 encounters the desired force against workpiece. As an immediate consequence, the prismatic pair 2−3A transmits zero force to 3A when direction of force 28 is aligned with the degree of freedom of 20−3A pair. It's apparent from FIG. 5, FIG. 6, FIG. 7 and FIG. 8 that degree of freedom of 20−3A pair can be made to align or “almost” align with the force 28, and either eliminate or substantially reduce the force transmitted to 3B, instead bulk of the force 28 is borne by the reaction 29 at the interface between 23 and 1.

The Summary: The core concept of the invention presented here is to split a robot arm into a pair of linkages that are actuated with respect to each other, but are otherwise floating in a carrier. Since the linkage pair is floating within its carrier, it transmits zero or negligible force to the carrier. The force at the end effector acts on one member of the linkage pair into which the robot arm is split into, and is directly transmitted to the second member of the pair, which in turn leans against and transfers this force to a suitably chosen rigid structure. In the rendition shown in FIG. 3, the floating pair is 4A−4B that is floating in the carrier 3A. In the rendition shown in FIG. 5, the floating pair is 20−23 that is floating in the carrier 3B. It should be noted that in both of the embodiments presented here the floating linkage pair is restricted to float along a single degree of freedom and completely eliminative any force or torque transmittal only along the floating degree of freedom. For example, in FIG. 3, the pair 4A−4B is only rotationally floating along the axis of revolute pair between 3A and the linkage pair 4A+4B. Similarly, in FIG. 5, the pair 20−23 is only linearly floating along the axis of prismatic pair between 3B and the linkage 20. Although this could be more commonly encountered situation, the floating need not be restricted to a single degree of freedom.

The floating linkage pair takes care of force or torque along those directions that are floating. Along the remaining directions, forces and torques can still be transmitted to the rest of the robot. However, by proper arrangement of dimensions of the linkage pair, designers can eliminate or significantly reduce the magnitude of such force or torque transmitted to the rest of the robot structure. For example, in the FIG. 3, the floating linkage 4A+4B is capable of transmitting a force to 3A. However by adjusting the dimension d, one can significantly reduce or in some cases completely eliminate the transmitted force. Likewise, in the arrangement presented in FIG. 5, the floating linkage 20+23 is capable of transmitting a bending moment (torque) as well as force in one direction to 3B. However by angularly aligning the direction of prismatic pair 3B−20 with force 28, one can significantly reduce or in some cases completely eliminate the transmitted force. Also by arranging the geometry of 20 and 23 in such a way that the two forces 28 and 29 are aligned, one can eliminate or substantially reduce the bending moments transmitted to 3B.

It should be noted that there are several more dimensional as well as joint configuration variations may arise from customization of this basic concept presented in this invention, and all of those should be treated as different embodiments of this invention.

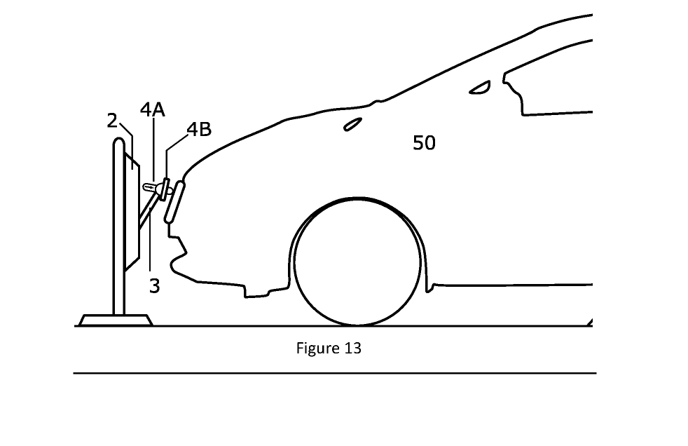

Application Example: With the rebirth of electric vehicles (EVs), the problem of charging of EVs without human intervention has become a critical element in successful deployment of EVs. There are two possible technologies that can be used to charge an EV without human intervention. One is an inductive charging and another is conductive charging. In order to alleviate range anxiety, EV are evolving in the direction of bigger and bigger batteries. Since an inductive charger cannot deliver electrical energy at higher rate, the conductive charging is the technology of choice. In this approach, the charging energy is delivered to EV by a robot. Using its articulation, the robot compensates for parking misalignments associated with each time the EV is parked on the charging spot. Having compensated for the misalignments, the robot arm then pushes one half of a charging connector against its counterpart attached to the EV. Specific points to note in this case are (i) the robot arm is expected to deliver a particular predetermined force to the mating two halves of the charging connector, (ii) the EV is stationary at the time the robot is attempting to establish a charging connection, (iii) the charging robot needs to be placed at or near the location an EV will be parked, and consequently needs to be a compact device that consumers or parking lot operators can accept in their home garage or public charging sport respectively. If such a charging robot is compact it will also not come in the way of cars driving in and around the concerned charging spot. These key requirements of an EV charging robot make it a perfect application for innovation presented in this patent. FIG. 12 shows how the arrangement originally shown in FIG. 3 can be used for an EV charging robot. FIG. 13 also shows an embodiment of this invention in which a pusher pin or a pull pin 4A leans on an EV either to extract a charging plug out or to push a charging plug in.

What is presented in this patent application are only few representative embodiments of the core innovation. There are countless situations where this innovation can be applied. Any variant embodiments of this innovation are anticipated by this disclosure and hence are to be considered as part of this patent.

1. What is claimed is:
a. a first kinematic link,
b. a second kinematic link,
c. a third kinematic link,
d. an actuating means to move the second kinematic link with respect to the first along a first degree of freedom,
e. a kinematic joint allowing free motion between the first kinematic link and the third kinematic link along at least the first degree of freedom.
